(19) United States
(12) Patent Application Publication
(10) Pub. No.: US 2023/0136094 A1
(43) Pub. Date: May 4, 2023

(54) AUTOMATIC, PERSONALIZED, AND EXPLAINABLE APPROACH FOR MEASURING, MONITORING, AND IMPROVING DATA EFFICACY

(71) Applicant: ADOBE INC., SAN JOSE, CA (US)

(72) Inventors: FAN DU, MILPITAS, CA (US); RYAN A. ROSSI, SAN JOSE, CA (US); EUNYEE KOH, SAN JOSE, CA (US); SUNGCHUL KIM, SAN JOSE, CA (US); HANDONG ZHAO, SAN JOSE, CA (US); KESHAV VADREVU, SAN JOSE, CA (US); SAURABH MAHAPATRA, SUNNYVALE, CA (US); VASANTHI SWAMINATHAN HOLTCAMP, FREMONT, CA (US)

(21) Appl. No.: 17/513,571

(22) Filed: Oct. 28, 2021

(51) Int. Cl. G06Q 30/02; G06N 5/04; G06F 16/215; G06K 9/62; G06N 3/04

(52) U.S. Cl. CPC G06Q 30/0205; G06N 5/045; G06F 16/215; G06K 9/6256; G06N 3/0454

(57) ABSTRACT

A method of determining efficacy of a dataset includes receiving data from a data source, wherein the data comprises a plurality of fields of unknown efficacy; mapping the data based on a plurality of data quality metrics and based on attributes of the plurality of fields wherein meta-features for the data are obtained; predicting a value for each of the plurality of data quality metrics using a ML model that takes the meta-features as input, wherein the value indicates whether a corresponding data quality metric is suitable for measuring efficacy of the fields; selecting a data quality metric based on the value, wherein the data quality metric measures an efficacy of the fields; and monitoring the efficacy of the fields in the data received from the data source based on the data quality metric.

### BACKGROUND

### 1. Technical Field

Embodiments of the disclosure are directed to an intelligent system for automatically learning and measuring the efficacy of a dataset, detecting data efficacy issues, personalize data efficacy metrics based on user needs, and recommending proper solutions to enhance the data efficacy.

### 2. Discussion of the Related Art

Modem companies rely on data to monitor the health of their businesses, drive their day-to-day operations, and guide their decision-making processes. The efficacy of the data is the spine of the data-driven activities. Poor-quality data, with missing or incorrect information, will likely lead to faulty observations and compromise decisions, which can be quite costly. Despite its crucial role, the measuring, monitoring, and improving of data efficacy is often a time-consuming and challenging task.

First, to measure data efficacy, users have to manually define and compute a set of metrics for each data attribute and also configure an appropriate threshold per metric per attribute. This involves correctly configuring the metrics and thresholds, and monitoring and managing them. As fresh data streams into a modern data platform in real-time, a holistic technology and system is needed to automatically monitor, measure, and maintain the data efficacy.

Second, the definition of data efficacy may change according to the role of the users. Certain metrics, such as completeness and redundancy, are relevant to data engineers, while marketers may be interested in usability metrics to verify the value distribution of the attributes they are relying on when creating customer segments. It is challenging to manually curate data efficacy measures that are personalized for the users.

Finally, diagnosing and improving the data when its efficacy is poor can cost significant engineering resources. Sometimes, even a small fix requires weeks to be resolved, which may delay marketers' campaigns or even compromise business decisions.

A major stream of related work focuses on the research and design of advanced data quality or efficacy metrics, which provide abundant good examples and guidelines that are useful for designing new data quality metrics. However, these metrics are often defined for a specific domain application or dataset, without an automatic mechanism for generalizing them to new datasets. Users still need to manually select which metrics to use and specific thresholds for differentiating good and poor quality.

Many existing commercial data tools are rule-based and require domain experts to define which data efficacy statistics to use and the thresholds to detect such issues. This is costly, requiring significant manual effort, and impractical as customers and the data important to them come from a wide variety of different domains and verticals, and each of them has their own data issues, importance of those issues, metrics, and so on. It is known that a significant part of customers, (or even analysts or data scientists) time is spent on data cleaning and efficacy issues. Besides the manual effort and monetary cost associated with defining such rules, the rules are also static and become stale quickly in a constantly changing and evolving environment.

### SUMMARY

Exemplary embodiments of the disclosure as described herein provide an explainable recommender service with personalized data quality scores powered by an machine learning (ML) approach, which differs from services that focus on data viewing and profiling. To overcome these limitations, embodiments of the disclosure provide an automatic data efficacy and insight system that leverages meta-learning. One or more embodiments introduce different learning approaches for data profile efficacy that are generalizable and adaptive across domains. Embodiments of the disclosure also introduce novel techniques for monitoring anomalies in the history of data efficacy scores and for generating recommendations for improving the efficacy of a dataset or a segment of customer profiles.

According to an embodiment of the disclosure, there is provided a method of determining efficacy of a dataset. The method includes receiving, by a machine-learning (ML) based efficacy scorer, data from a data source, wherein the data comprises a plurality of fields of unknown efficacy; mapping, by a machine-learning (ML) based efficacy scorer, the data based on a plurality of data quality metrics and based on attributes of the plurality of fields wherein meta-features for the data are obtained; predicting, by a machine-learning (ML) based efficacy scorer, a value for each of the plurality of data quality metrics using a ML model that takes the meta-features as input, wherein the value indicates whether a corresponding data quality metric is suitable for measuring efficacy of the fields; selecting, by a machine-learning (ML) based efficacy scorer, a data quality metric based on the value, wherein the data quality metric measures an efficacy of the fields; and monitoring, by an anomaly monitor, the efficacy of the fields in the data received from the data source based on the data quality metric.

According to an embodiment of the disclosure, there is provided a system for determining efficacy of a dataset. The system includes a plurality of data sources, a statistical efficacy scorer, a machine-learning based efficacy scorer, an efficacy recommender, an anomaly monitor, and a user interface that includes dashboard visualizations and is configured to receive user inputs. The machine-learning based efficacy scorer is configured to train a machine-learning (ML) model than predicts a value for each of a plurality of data quality metrics. The machine-learning (ML) model is trained by computing, for each dataset in a set of training datasets, a meta-feature matrix M of size n by f, wherein n is a number of attributes across all datasets, and f is a number of meta-features, wherein meta-features are derived for every attribute of each dataset; computing, for each dataset in the set of training datasets, a data quality metric matrix Q of size n by m wherein m is number of data quality metrics across all the datasets, and each of the m data quality metrics is computed for every data column/attribute for all the datasets; providing a ground truth matrix Y of ground-truth data quality labels, wherein each row in Y corresponds to a data-column in some dataset and each columns represents an actual ground-truth data quality metric; and learning a function ƒ that maps M and Q to Y, such that ƒ([M Q])=Y. Given a new unseen data-attribute/column Xₜₑₛₜ from a user, a relevant data quality metric is predicted as Yₜₑₛₜ=ƒ([ϕ(Xₜₑₛₜ)ψ(Xₜₑₛₜ)]), wherein the meta-feature vector is ϕ(Xₜₑₛₜ) and the data quality metrics is ψ(Xₜₑₛₜ), and the relevant predicted data quality metrics is presented to the user as a data quality recommendation.

According to an embodiment of the disclosure, there is provided a method of determining efficacy of a dataset. The method includes determining, by a statistical efficacy scorer, a set of data quality metrics and statistics; scoring, by the statistical efficacy scorer, a field in a dataset of unknown efficacy with the set of data quality metrics and statistics by evaluating a weighted sum of one or more of the computed set of data quality metrics, wherein an efficacy score of the field is derived; presenting, by the statistical efficacy scorer, the efficacy score to the user along with an explanation of how the efficacy score was derived; receiving, by the statistical efficacy scorer, adjustments user of weights for one or more of the computed set of data quality metrics from the user, wherein an adjusted set of data quality metrics is derived; and monitoring, by an anomaly monitor, data efficacy of a new, incoming dataset with the adjusted set of data quality metrics.

### BRIEF DESCRIPTION OF THE DRAWINGS

FIG. 1 illustrates an exemplary system architecture, according to an embodiment of the disclosure.

FIG. 2A illustrates an example of how an efficacy score is derived, according to an embodiment of the disclosure.

FIG. 2B shows how scoring results of a hierarchical data schema are visualized, according to an embodiment of the disclosure.

FIGS. 3A and 3B illustrate recommendations and visual explanations for combining neighboring values, according to an embodiment of the disclosure.

FIGS. 4A and 4B illustrate recommendations and visual explanations for standardizing synonymous values and removing invalid values, according to an embodiment of the disclosure.

FIG. 5A is a flow chart of a process that scores hierarchical data, according to an embodiment of the disclosure.

FIG. 5B is a flowchart of a process of training and using an ML model, according to an embodiment of the disclosure.

FIG. 5C is a flowchart of a process of monitoring efficacy and detecting anomolies, according to an embodiment of the disclosure.

FIG. 5D is a flowchart of a process of recommending proper solutions to enhance the data efficacy, according to an embodiment of the disclosure.

FIG. 6 illustrates an exemplary computing device that may be used to perform one or more methods of the disclosure.

### DETAILED DESCRIPTION

Current approaches for measuring data efficacy involve users manually defining and computing a set of metrics for each data attribute, configuring an appropriate threshold per metric per attribute, and monitoring and managing them. However, the definition of data efficacy changes according to the role of the users. Certain metrics, such as completeness and redundancy, are relevant to data engineers, while marketers may be interested in usability metrics to verify the value distribution of the attributes they are relying on when creating customer segments. In addition, diagnosing and improving the data when its efficacy is poor can cost significant engineering resources.

An approach according to an embodiment overcomes the issue of simply computing all such data quality metrics for each attribute of a new customer dataset, and then alerting the customer based solely on the metrics, without considering any prior knowledge learned from previous customers with similar datasets and quality issues. By leveraging this information, a system according to an embodiment recommends to a user actual data quality metrics that they are likely to find important, without overloading the user with other data quality metrics that may not be of interest to them, based on the domain and data characteristics. In other words, a system according to an embodiment recommends to the user more personalized data efficacy metrics based on previous metrics of customers with similar data. A system according to an embodiment leverages historical datasets where the data efficacy metrics and thresholds have been manually identified. By training an ML model on these datasets, the system automatically detects data efficacy metrics when given a new dataset of interest. In addition, a system according to an embodiment provides an interactive dashboard where the data efficacy metrics and recommended solutions are visually presented and explained to the users.

The following terms are used throughout the present disclosure.

The term “dataset” refers to a collection of data fields, where each data field contains an item of information, and where the collection of data fields are possibly organized into an array of rows and columns.

The term “data attribute” refers to the type of information, such as “age”, in a column or a field in a dataset.

The term “metafeature” refers to anything that helps to characterize a data attribute. In general, a meta-feature can be defined as a function f over the data-attribute that maps a data attribute of arbitrary length to a single value. An example is a mean.

The term “data quality metrics” refers to data properties such as data types, length, and recurring patterns, the number of unique and missing values, quantile statistics, such as min, max, median, Q1, Q3, etc., and further statistics, such as count, mean, mode, standard deviation, sum, skewness, and histogram.

The term “data efficacy” refers to the reliability or “goodness” of information in the data fields of a dataset, as measured by one or more data quality metrics. A data efficacy score ranges from 0% (completely unreliable) to 100% (completely reliable).

The term “machine learning” refers to the study of computer algorithms that are automatically improved through the use of training data and experience.

The term “user profile” or “customer profile” refers to a data file contains information about a real-world person, such as a customer. In the context of digital marketing, user profiles are used to create audience segments for running campaigns.

The term “categorical value” refers to string values, such as email addresses, customer first/last names, URLs, etc.

A system according to an embodiment of the disclosure includes the following components.

Efficacy Scorer: An automatic and personalized approach for scoring the efficacy of a dataset.

Efficacy Monitor: An automatic approach for monitoring data efficacy scores and alerting users of anomalous score changes.

Efficacy Recommender: An explainable approach for recommending proper solutions for improving data efficacy.

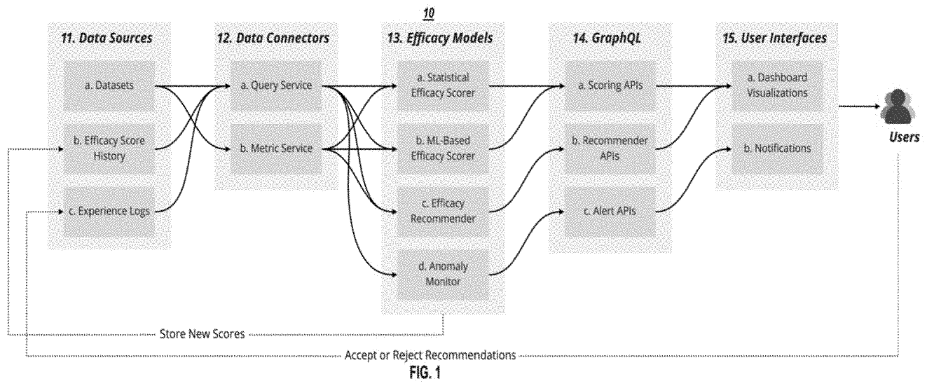

Efficacy Dashboard: A suite of novel visualizations and dashboards for visually presenting and communicating data efficacy issues and recommended solutions with end-users. FIGS. 1A, 1B, 3 and 4 illustrate examples of a dashboard according to embodiments.

System architecture and data pipeline that seamlessly connects the above mentioned modules end-to-end, from data sources to client browsers.

### 1. System Architecture

FIG. 1 illustrates the architecture of a system according to an embodiment. Referring to FIG. 1, a system 20 according to an embodiment includes the following modules: Data Sources 11, Data Connectors 12, Efficacy Models 13, GraphQL 14, and User Interfaces 15.

The data sources 11 store customer data, scoring history, and experience logs, and include datasets 11a, an efficacy score history 11b, and experience logs 11c.

The data connectors 12 provide data access APIs for our system to query datasets stored in various databases and formats and include a query service 12a and a metric service 12b. The efficacy models 13 include a statistical efficacy scorer 13a, an ML-based efficacy scorer 13b, an efficacy recommender 13c, and an anomaly monitor 13d. The query service 12a collects data from the datasets 11a, the efficacy score history 11b and the experience logs 11c, computes the computer profile statistics described in section 2(a), below, and passes the collected data and profile statistics to each of the statistical efficacy scorer 13a, the ML-based efficacy scorer 13b, the efficacy recommender 13c, and/or the anomaly monitor 13d. The metric service 12b passes data from the datasets 11a to each of the statistical efficacy scorer 13a, the ML-based efficacy scorer 13b, and/or the efficacy recommender 13c.

The statistical efficacy scorer 13a performs the statistical efficacy scoring described in sections 2(b) and (c), below. The ML-based efficacy scorer 13b performs the ML-based efficacy scoring and personalization described in section 3, below. The efficacy recommender 13c generates the explainable efficacy recommendations described in section 5, below, and the anomaly monitor 13d performs the efficacy monitoring described in section 4, below. New scores will be sent back to data sources 11 and stored in the efficacy score history 11b.

GraphQL is a query language for APIs. In general, this is a middleware that provides APIs for frontend UIs to retrieve data from the backend. The graphQL module 14 includes a scoring APIs sub-module 14a, a recommender APIs sub-module 14b, and an alert APIs sub-module 14c. The user interfaces 15 include dashboard visualizations 15a and notifications interface 15b. The scoring APIs sub-module 14a passes results from the statistical efficacy scorer 13a and the ML-based efficacy scorer 13b to the dashboard visualizations 15a. The recommender APIs sub-module 14b passes results from the efficacy recommender 13c to the dashboard visualizations 15a, and the alert APIs sub-module 14c passes results from the anomaly monitor 13d to the notifications interface 15b.

Users' acceptance or rejection of the efficacy recommendations displayed in the dashboard visualizations 15a are stored in the experience logs 11c and used to improve the efficacy recommender 13c.

### 2. Statistical Efficacy Scoring:

First will be described a statistical approach for scoring the efficacy of a dataset, which is particularly useful in two scenarios: (1) when a customer opts out of training ML models on their data for privacy considerations; and (2) when the system is in a coldstart state with limited ground-truth labels for training the ML model. The statistical approach includes three steps as follows:

(a) Computer profile statistics: Given a dataset of, e.g., user or customer profiles, a first step is to compute a set of data quality metrics, such as defined above. This set of metrics could be manually defined by a domain expert, or for the case of automatically determining the relevant data quality metrics, be derived for use later in the pipeline. To compute these quickly, techniques are used to obtain provably accurate estimates while requiring only a tiny sample of the data.

(b) Score a data field: To score a data field when the data quality metrics of interest are known, the metrics are computed and combined into a single data efficacy score. The score of a data field is computed by a weighted combination of individual data quality metrics. For example, a weighted mean x̅=Σᵢ₌₁ⁿwᵢxᵢ is used, where xᵢ is an individual metric and wᵢ is its weight. Otherwise, a default set of data quality metrics is used for scoring. In both cases, users make adjustments regarding which metrics to include, and the weight associated with each metric. A system according to an embodiment also explains to a user through the dashboard visualizations how that score is derived and what it entails.

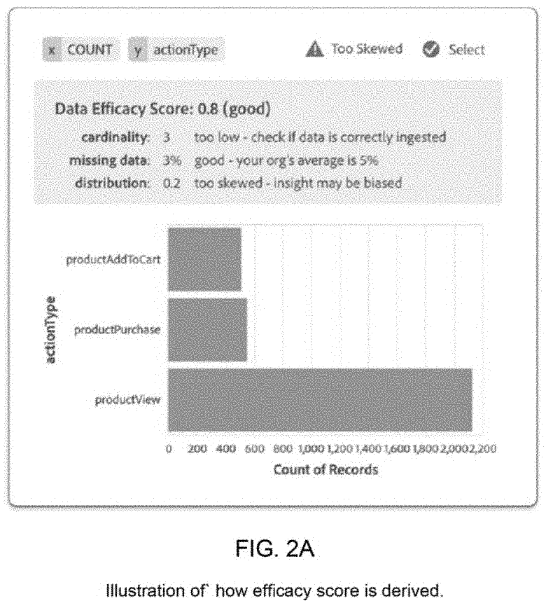

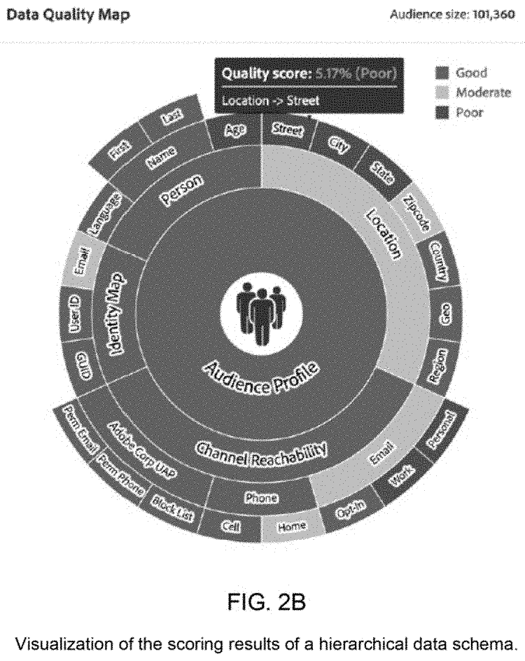

FIG. 2A shows a bar chart created by an analyst from a dataset of website visit logs. In the bar charts, actionType means different actions taken by website visitors. The actions include: “viewing a product”/“adding the product to a cart”/“purchasing the product”. The Count of Records means how many times each action occurred in the log. Three metrics per user configuration or model recommendation are displayed that measure the quality of the data underlying this barchart: (1) Cardinality, which is the number of unique values. This chart has only three: “view product”/“add product to cart”“purchase product”. (2) Missing data, which is the percentage of rows that have no value for an actionType, such as a null or an empty string. (3) Distribution, which is the skewness of the data distribution, i.e., the bars, as measured by mode skewness. The overall Data Efficacy Score is a weighted combination of these three metrics, as detailed above.

(c) Score a data hierarchy: Modern database management systems allow storing complex datasets in a hierarchical schema. Based on the tree structure specified by a hierarchical schema, an efficacy score of a “parent” data field is computed by aggregating the scores of its “children” data fields. For instance, in a data onboarding process, the customer uploads a set of personal contact data with fields such as “Personal Email” and “Fax Phone”. After mapping these fields to the child fields of “Personal Contact Details”, the efficacy score of “Personal Contact Details” is computed by aggregating the scores of “Personal Email” and “Fax Phone”.

FIG. 2B shows how scoring results of a hierarchical data schema are visualized. The hierarchy shown in FIG. 2B has an Audience Profile at its root node, with first intermediate level nodes directed to identity, reachability, persons and location, second level nodes, some of which are leaf nodes, that include, inter alia, name, age, street, city, state, phone, zip code, and email, etc., and leaf nodes that include, inter alia, first name, last name, cell phone number, home phone number, opt-in email, work email, and personal email, etc. The dark grey shaded fields in FIG. 2B have poor data quality; the light shaded fields have moderate quality, and the medium grey shaded fields have good quality. The figure indicates that the data quality of the Location->Street node is 5.17%, which is poor.

### 3. ML-based Efficacy Scoring & Personalization

According to an embodiment of the disclosure, given training data where there is a set of datasets that customers have previously used, and attributes in the customer datasets for which the data quality metrics and thresholds are known that users found useful, e.g., skew is important for “Age” attribute with these thresholds, then, an ML model is trained using that data and applied to infer the most relevant “data quality metric and threshold” for any given new unseen attribute from a new unseen customer dataset. According to an embodiment, this is accomplished by first mapping every attribute in the corpus of customer datasets to a metafeature vector, which is used by the model to identify similar attributes and to learn preferences (data quality metrics and thresholds) for those attributes from the user. Hence, given a new customer dataset, an approach according to an embodiment works as follows: (1) map each of the attributes to a meta-feature vector, and then given this vector, (2) apply the model. The model outputs the recommended data quality metrics and thresholds along with their scores.

Training data is generated by showing a set of users a data attribute/field and a list of data quality metrics for the attribute/field, and then prompting the users to select which data quality metrics are important/meaningful with respect to the data efficacy/quality for this specific data attribute/field. The user can be prompted to rate the importance of the data quality metric from 1-10, or simply prompted to select the important data efficacy quality metrics for each specific data column/attribute.

According to an embodiment, the supervision would be the metrics and thresholds used by other customers that were found useful for specific attributes, and that are characterized by the meta-features. There are a few ways to set up the ML task. An approach according to an embodiment is based on collaborative filtering, where there is a large sparse tall-and-skinny matrix of data fields (rows) by data quality metrics. The ML-based approach includes three steps as follows:

(a) Obtain efficacy labels: The task of automatic data efficacy is formulated as a meta-learning task where the goal is to quantify what it means for any dataset, or attribute from the dataset, to be of poor quality, or the inverse, of high quality. Suppose there is a set of datasets Dₜᵣₐᵢₙ={D₁, . . . ,Dₙ}, and for each dataset Dᵢ, or attribute of that dataset, there is a label yᵢ that indicates the quality of the dataset, or, in the case of attributes, there is a label for each of the attributes in the dataset, hence {(Dᵢ, yᵢ)ᵢ₌₁ⁿ}. For each dataset, Y can be considered a matrix of ground-truth labels that are used for training where each row in Y corresponds to a data-column in a dataset and the columns represent the actual ground-truth data quality metrics, where Yik=1 if data quality metric k is important for data-column/attribute i.

(b) Compute meta-feature matrix: Further, according to an embodiment, suppose there is a set of functions ψ that characterize the data quality. These are hand-selected to specifically capture the quality of the data, or more generally, the data quality characteristics important to the underlying domain, task, etc. Using ψ, a data quality matrix Q=ψ({D₁, . . . ,ₙ}) are obtained for all the training datasets. Q is a matrix of size n by m where n=number of attributes across all datasets and m=total data quality metrics across all the datasets. In addition, a meta-feature matrix M is obtained from the training dataset, where M is of size n by f where n=number of attributes across all datasets in the corpus, and f=number of meta-features.

(c) Training efficacy model: According to an embodiment, an ML task learns a data efficacy model F that maps the data quality matrix Q and the metafeature matrix M to their corresponding data quality labels Y. For learning the function F, any standard ML model can be used, such as a neural network/MLP, regression or classification trees, and so on. Then, given a new dataset Dₜₑₛₜ, with m attributes but no labels (unsupervised), the meta-features xₜₑₛₜ−φ(Dₜₑₛₜ) and data quality metrics qₜₑₛₜ=ψ(Dₜₑₛₜ) are obtained for the dataset, wherein φ are the metafeature functions, or for each of the attributes if at an attribute-level, are obtained, and a data efficacy score F(φ(Dₜₑₛₜ), ψ(Dₜₑₛₜ))∈[0,1] is directly derived.

For example, suppose there is a set of datasets where the metrics of interest have been defined by an expert for each attribute, then the metrics for each attribute are used as a form of supervision (labels), and a model is learned based on this, such that when a new customer dataset is received, the model is applied to estimate a score on how likely the customer will care about a certain data quality metric, based on the data characteristics of the attribute, which are captured via the meta-features, and the similarity of these meta-features to those labeled in the training data. From this, a system according to an embodiment recommends to the customer the data quality metrics that are likely to be important.

An option when training the data efficacy model F is to incorporate information from user profiles. A user profile contains information about a real-world person, such as a customer. In the context of digital marketing, user profiles are used to create audience segments for running campaigns. An example audience segment is users who are between 30-40 years old and live in California. An example campaign would be to send promotional email ads to the above audience segment. Other application domains of user profiles include healthcare, where a user profile contains the demographic information and medical history, such as symptoms, diagnoses, treatments, of a patent, and education, where a user profile contains the demographic information and academic history, such as course, scores, awards, of a student.

### 4. Efficacy Monitoring

Monitoring a field involves detecting when the shape of the data has a sudden change (e.g., caused by a newly inserted data batch) and sending alerts. For numerical fields, the “shape” of the data is easily characterized by its distribution. For categorical values, embedding is applied to characterize its “shape”, where each embedding is a fixed-length feature vector that captures the high-level semantic meaning of the string. For example, if an incoming data batch misused the “customer name” field to store a “URL”, the embedding/feature vector of the “URL” will have a significant difference, defined by a threshold, with respect to the embedding of a “customer name”. Two exemplary embodiments for automatically monitoring data efficacy scores and alerting users of anomalous score changes will be described:

(a) A statistical approach assumes that the feature values that have been stored up until now are normal or at least many of them are sampled from a certain distribution. Then, one of the most popularly used statistical approaches that detect outliers is a Box and whisker plot (or quartile values). It uses five numbers that describe a feature: the minimum, first quartile, median, third quartile, and maximum. If a new value is placed out of the minimum/maximum value when considering the Inter-Quartile Range (IQR), it will be considered as an anomaly.

(b) An ML-based approach uses autoencoder, which mainly targets categorical fields or fields that do not follow the conventional distribution functions. For example, for categorical fields, an autoencoder learns embeddings for each categorical value, which is a fixed-length scalar vector that contains its semantics. Then the fixed-length scalar vector is compressed into a condensed vector that will be used to reconstruct the original input vector. By doing this, the model will learn the core patterns needed to compress and reconstruct the input vector. Then, if an unseen vector is too different from the dominant patterns, the model will struggle with reconstructing it and produce high reconstruction error, which will be a signal for alerts.

### 5. Explainable Efficacy Recommendations:

Beside automatically measuring the efficacy of a dataset and detecting data efficacy issues, a system according to an embodiment also recommends proper solutions to enhance the data efficacy. This feature would be useful for marketers who want to improve the data quality of a target segment and for data engineers who want to cleanse or repair data during the ingestion workflow. Based on the characteristics of each data attribute that has poor efficacy, a system according to an embodiment uses five strategies to generate the efficacy recommendations:

(a) Interpolating missing values: The most common recommendation for repairing an attribute is to interpolate the missing values from the overall population, e.g., mean or median for numerical and ordinal attributes, most frequent strings for categorical attributes. This strategy is particularly useful for applications where missing values are prohibited, e.g., each customer profile must have an “Age”.

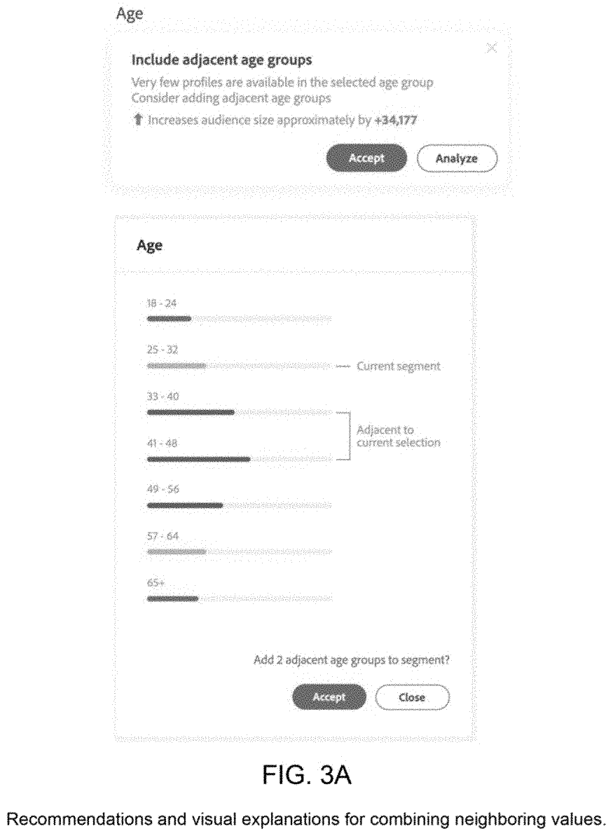

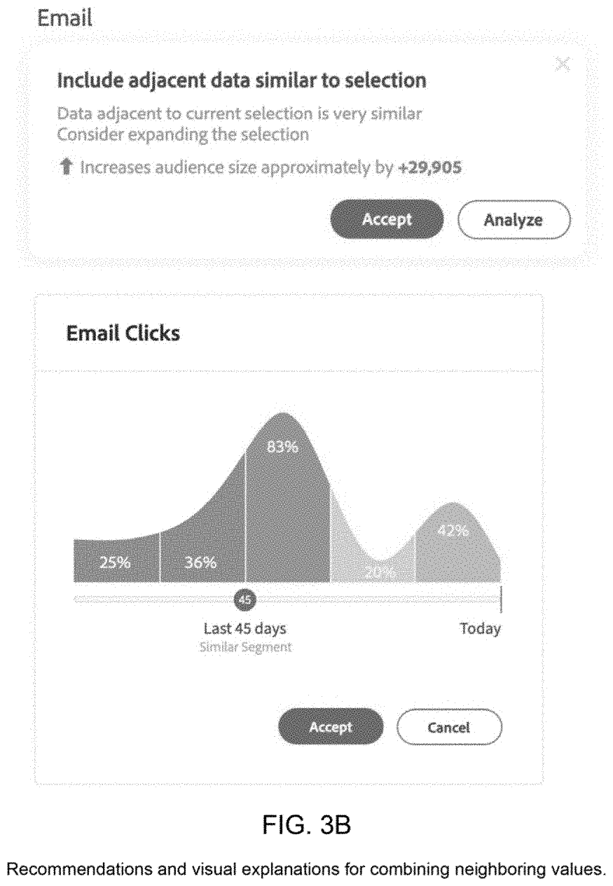

(b) Including neighboring values: When additional data are available, a system according to an embodiment recommends that users add data whose attribute values are in a neighboring range to the current data. For example, as illustrated in FIG. 3A, a marketer has created a segment with the rule “Age between 25-32”, labeled as “Current Segment” in the bar graphs. The shading of the graphs is indicative of the data quality, similar to the shading in FIG. 2B. A system according to an embodiment determines that by extending the segment to also include “Age between 33-40” and “Age between 41-48”, the efficacy score of the segment will increase, and thus proposes this recommendation to the user, as shown by the “Accept” buttons. Another example is illustrated in FIG. 3B. In this example, the figure shows percentage of people who have email clicks in 15-day blocks. The user's original segmentation rule is “people who has email clicks in last 30 days”. The model found many high-quality profiles in the neighboring range of “30-45 days” and thus recommended the rule adjustment to “last 45 days”, as shown in the figure.

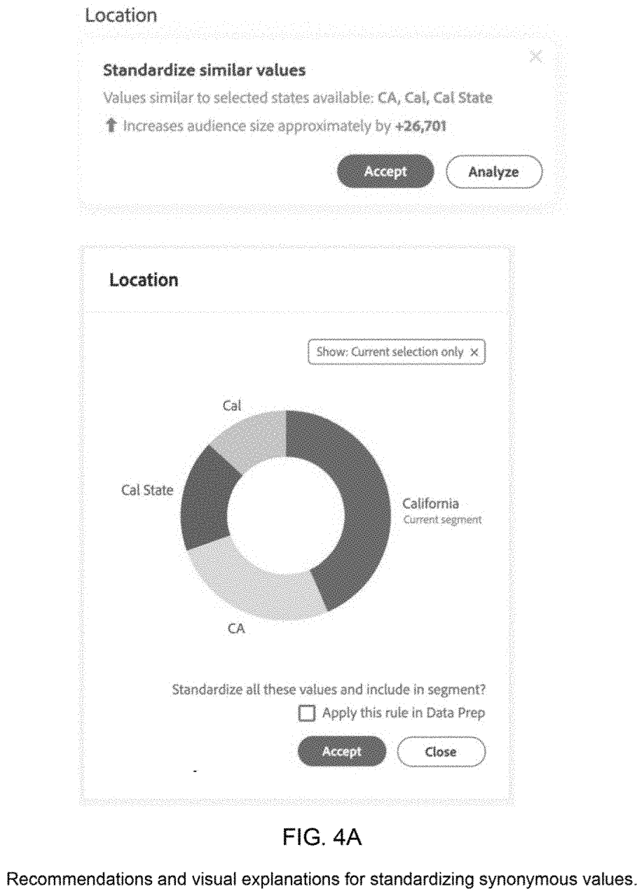

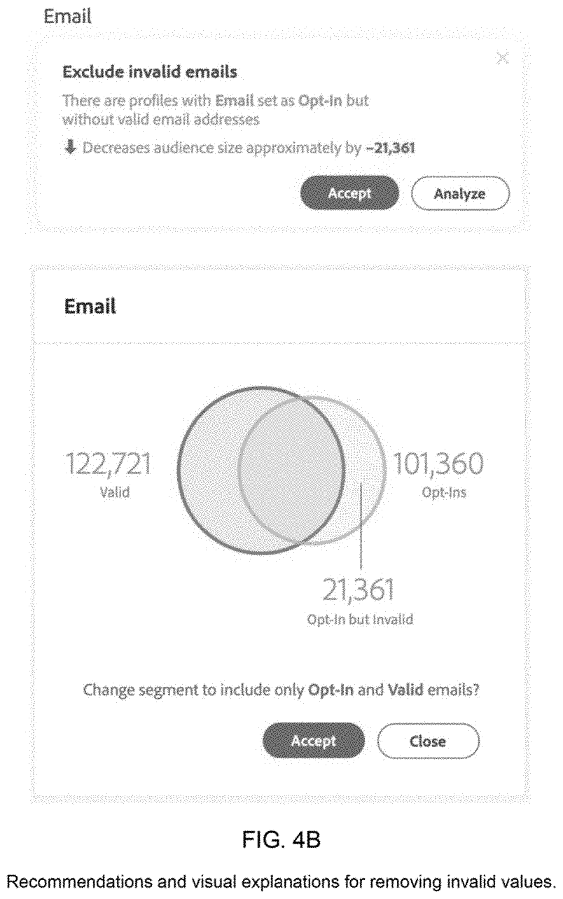

(c) Standardizing synonymous values: Synonymous values (or typos) commonly exist in categorical attributes and are standardized to improve data efficacy. A system according to an embodiment implements an approximate synonym matching algorithm that uses both WordNet, a knowledge graph of common synonyms, and case insensitive Levenshtein distance, a string metric for measuring the difference between two sequences. This approach not only identifies synonymous values but also support different capitalization conventions and forgive typos. For example, as illustrated in FIG. 4A, a marketer has created a segment with the rule “State equals California”, as indicated by the “Current Segment” label. A system according to an embodiment detects several synonyms of “California”. E.g., “Cal”, “Cal State”, “CA”, etc., that also exist in this profile dataset and recommends standardizing them into one, and thus proposes this recommendation to the user, as shown by the “Accept” buttons. Applying this recommendation will increase both the efficacy and size of this segment, since additional profiles will be included after the standardization.

(d) Removing invalid values: A system according to an embodiment also uses domain-specific rules to cleanse data. For example, illustrated in FIG. 4B, based on the string patterns of valid email addresses, a system according to an embodiment recommends excluding profiles with invalid email addresses, and thus proposes this recommendation to the user, as shown by the “Accept” buttons.. The recommendation is visualized in a Venn diagram to explain to the users the effect of accepting this recommendation.

(e) Merging mutual attributes: Due to inconsistent data schema, the same information may be stored in multiple attributes, causing missing values in one attribute or redundant values among multiple attributes. Mutual attributes are not easy to detect, especially when they are named inconsistently, e.g., customers' emails stored in four attributes: “Email”, “Account”, “Info”, “Contact”. To address this challenge, in an embodiment, a hybrid deep learning model was trained to understand each data column attribute, including both a header (friendly name) and a column value. A hybrid deep learning model according to an embodiment includes a sentence-level recurrent neural network (RNN) header module and character-level convolutional neural network (CNN) cell value module, and automatically measures the semantic similarity among data attributes. The model then provides the efficacy recommendation of the same data attribute clusters based on the computed scores.

A hybrid deep learning model according to an embodiment is defined as

G_{ce}(c)=W[g_{gru}(h_{c}); g_{cnn}(x_{c})],

where g_{gru}(h_{c}) is a gated recurrent network for the header h_{c}, defined below, g_{cnn}(x_{c}) is a convolutional network for the column content, defined below, [; ] means concatenation of two vectors and W is a parameter matrix. A column c is represented by a tuple of a header h_{c} and cells of content x_{c}. A header h_{c} is defined as a string that can be either a word sequence or meaningless characters. Cells of content x_{c} are a list of values of any data type. The column encoder, denoted by G_{ce}, is used to convert a column into a latent vector in low dimensional space, i.e. G_{ce}: c→R^{d}.

For the header, it is assumed that each header is a string type and can be tokenized into a list of words, and that each word can be mapped to a pretrained word embedding in a d-dimensional latent space. Formally, define a header h={w₁, . . . , w_{|h|}}, where wᵢ is a word in a vocabulary V. Let w∈R^{d} be an embedding of word w. A header encoder according to an embodiment encodes the sequential order of words using a gated recurrent unit (GRU):

g_{gru}(h_{c})=GRU({w₁, . . . , w_{|hc|}}),

where g_{gru} produces the embedding by taking the last output of GRU cell on w_{|hc|}.

For each column with cells alone, first randomly sample m cells out of all cells and concatenate them into a long string. Then, use a character-level convolutional neural network to encode this long string. Specifically, let the string x_{c} corresponding to the column c be a sequence of characters {z₁, . . . , z_{|xc}|}. Each character zᵢ can be embedded into a d-dimensional latent space. Therefore, by stacking all |x_{c}|number of character embeddings, a matrix is obtained that is denoted by x_{c}∈R^{|xc|×d}. The character-level encoder g_{cnn} is defined as follows.

g_{cnn}(x_{c})=W_{c} max pool(σ(conv₂(σ(conv₁(x_{c}))))),

where conv₁ and conv₂ are 1D convolutional layers, σ is activation function ReLU, maxpool is 1D max pooling layer and We is a parameter matrix.

Details of features extracted for model training are described below.
(i) Cell-level statistics: A model according to an embodiment extracted 27 global statistical features from each column, including the number of non-empty cell values, the entropy of cell values, fraction of {unique values, numerical characters, alphabetical characters}, {mean, std. dev.} of the number of {numerical characters, alphabetical characters, special characters, words}, {percentage, count, any, all} of the missing values, and {sum, min, max, median, mode, kurtosis, skewness, any, all} of the length of cell values.
(ii) Character-level statistics: A model according to an embodiment also extracted statistical features for a set of ASCII-printable characters, including digits, letters, and several special characters, from each column. Given a character c, the model extracted 10 features: {any, all, mean, variance, min, max, median, sum, kurtosis, skewness} of the number of occurrences of c in the cells.
(iii) Cell keywords: The above two kinds of features cover statistical information at different levels of granularity. A model according to an embodiment further considers word-level features by tokenizing all cell values in a column. After aggregating all unique values, the model chooses the top |V_{cell}| frequent values as the keyword vocabulary V_{cell}.
(iv) Header features: In some cases, a header directly reflects the meaning of the column, which is used to establish a correspondence to a candidate label. Similar to cell keywords, a model according to an embodiment also tokenizes headers and labels to enlarge the keyword set V,−. . .

A data efficacy monitoring system according to an embodiment has many real-world applications in digital marketing, healthcare and education. In digital marketing, a system according to an embodiment helps data engineers monitor data quality of databases and send alerts when a new data batch has caused a sudden decrease in data quality metrics, so that the engineers debug the batch. In addition, a system according to an embodiment helps marketers review the data quality of user profiles before launching a campaign targeting those users, and help data analysts review the data quality of the data behind a dashboard or a chart, so that the marketers know if the observed insights are trustworthy for making business decisions. Applications in healthcare and education include helping a hospital or school monitor if the records of its patients or students have been correctly logged.

A real-world marketing application would be running a campaign for a new comedy show. A first step would be to create a list of segments that represent different groups of audiences, and then select a segment based on type of show, e.g. comedy. In this example, the segment is comedy fans in California between ages of 25 and 32 who have opted in for email. There are 100,000 customers in the segment, but the segment data quality is only 37%, i.e., only 37% of the data is accurate. A visualization such as that in FIG. 2B illustrates the data quality of the data attributes. For example, the data quality of the age, street, city and state attributes is poor, while the data quality of the zipcode, location and email attributes is moderate. A system according to an embodiment makes several recommendations to improve data quality. One recommendation is to include adjacent age groups: the system shows a bar graph of adjacent age groups colored by data quality. This is shown in FIG. 3A, where the shading of the 33-40 and 41-48 age groups indicates good data quality. Another recommendation is to standardize representation of “California”, and to infer the state from a customer's zipcode. This is illustrated in FIG. 4A. Another recommendation is to exclude invalid email addresses. FIG. 4B illustrates that effect of doing so: although the audience size is reduced, the data quality is improved, which saves marketers the effort of emailing to invalid addresses. Following these recommendation, audience size increased to 140,000 and data quality increased to 76%.

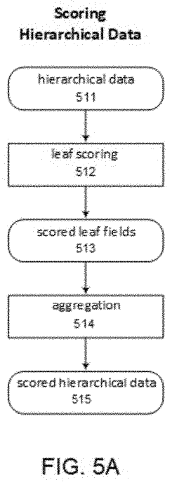

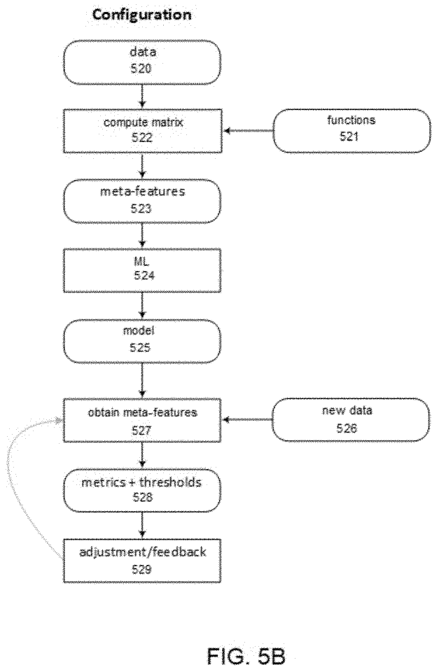

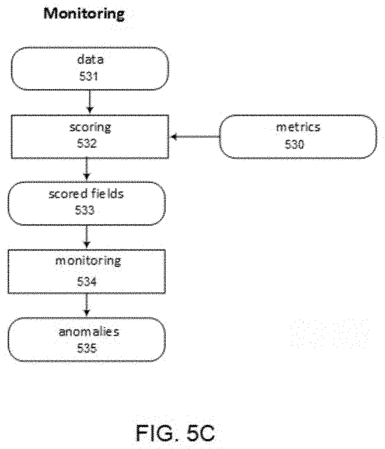

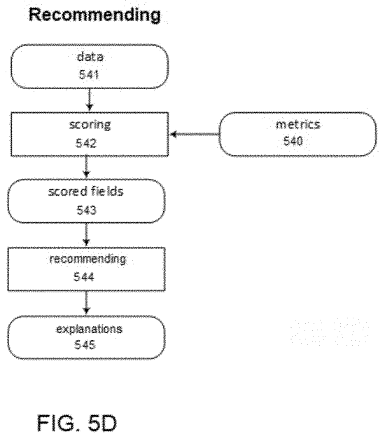

FIG. 5A is a flow chart of a process that scores hierarchical data. Referring to the figure, a scoring process begins at step 512 by scoring leaf nodes of hierarchical data 511, and outputting scored leaf nodes 513. The leaf nodes are scored by a method such as that disclosed in sections 2(a) and (b), above, or by an ML-based method such as that disclosed in the next section 3. At step 514, the scored leaf nodes are aggregated for each next level node, and this process is repeated until the root node is reached, after which scored hierarchical data 515 is output.

FIG. 5B is a flowchart of a process of training an ML model as described in section 3, above, and applying that model to infer the most relevant “data quality metric and threshold” for any given new unseen attribute from a new unseen customer dataset. Referring to the figure, a process begins by providing a set of datasets {(Dᵢyᵢ)ᵢ₌₁ⁿ} 520 defined as above, and, at step 522, applying a set of meta-feature functions ψ 521 defined as above to the set of datasets {(Dᵢyᵢ)ᵢ₌₁ⁿ} to compute a data quality meta-feature matrix Q=ψ({D₁, . . . ,ₙ}) 523 for all the training datasets. At step 524, an ML task is trained using the data quality meta-feature matrix Q 523 to generate an efficacy model 525 F that maps the data quality matrix Q into corresponding data quality labels. Then when a new set of datasets and corresponding metrics 526 is presented, the model 525 is applied at step 527 to the new data 526 to estimate a score 528 on how likely the customer will care about certain data quality metrics. At set 529, the user provides feedback to adjust how the model decodes the new data at step 526. Note that the user adjustments need not occur in real-time.

FIG. 5C is a flowchart of a process of monitoring efficacy and detecting anomalies, as described in section 4, above, according to an embodiment of the disclosure. Referring to the figure, a process begins at step 532 by scoring data 531 as described in sections 2 or 3, above, using the data quality metrics 530 computed as described in sections 2 or 3, above, and outputting a time series of fields 533 with data efficacy scores. The scored fields 533 are monitored at step 534, which outputs detected anomalies 535.

FIG. 5D is a flowchart of a process of recommending proper solutions to enhance the data efficacy, as described in section 5, above, according to an embodiment of the disclosure. Referring to the figure, a process begins at step 542 by scoring data 541 as described in sections 2 or 3, above, using the data quality metrics 540 computed as described in sections 2 or 3, above, outputting a fields 533 with data efficacy scores, and generating 544 the efficacy recommendations 545 with explanations.

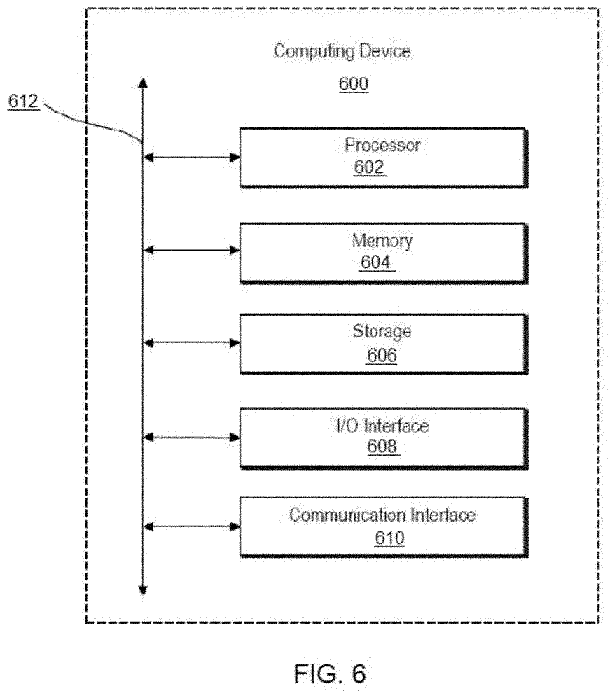

FIG. 6 illustrates a block diagram of an example computing device 600 that may be configured to perform one or more of the processes described above. One will appreciate that one or more computing devices, such as the computing device 600, may represent the computing system described above, such as the system 50. In one or more embodiments, the computing device 600 may be a mobile device, such as a mobile telephone, a smartphone, a PDA, a tablet, a laptop, a camera, a tracker, a watch, a wearable device, etc). In some embodiments, the computing device 600 may be a non-mobile device, such as a desktop computer or another type of client device 600. Further, the computing device 600 may be a server device that includes cloud-based processing and storage capabilities.

As shown in FIG. 6, the computing device 600 includes one or more processor(s) 602, memory 604, a storage device 606, input/output interfaces 608 (or “I/O interfaces 608”), and a communication interface 610, which may be communicatively coupled by way of a communication infrastructure, such as bus 612. While the computing device 600 is shown in FIG. 6, the components illustrated in FIG. 6 are not intended to be limiting. Additional or alternative components may be used in other embodiments. Furthermore, in certain embodiments, the computing device 600 includes fewer components than those shown in FIG. 6. Components of the computing device 600 shown in FIG. 6 will now be described in additional detail.

In particular embodiments, the processor(s) 602 includes hardware for executing instructions, such as those making up a computer program. As an example, and not by way of limitation, to execute instructions, the processor(s) 602 may retrieve (or fetch) the instructions from an internal register, an internal cache, memory 604, or a storage device 606 and decode and execute them.

The computing device 600 includes memory 604, which is coupled to the processor(s) 602. The memory 604 may be used for storing data, metadata, and programs for execution by the processor(s). The memory 604 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 604 may be internal or distributed memory.

The computing device 600 includes a storage device 606 for storing data or instructions. As an example, and not by way of limitation, the storage device 606 includes a non-transitory storage medium described above. The storage device 606 may include a hard disk drive (HDD), flash memory, a Universal Serial Bus (USB) drive or a combination these or other storage devices.

As shown, the computing device 600 includes one or more I/O interfaces 608, which are provided to allow a user to provide input to (such as user strokes), receive output from, and otherwise transfer data to and from the computing device 600. These I/O interfaces 608 may include a mouse, keypad or a keyboard, a touch screen, camera, optical scanner, network interface, modem, other known I/O devices or a combination of such I/O interfaces 608. The touch screen may be activated with a stylus or a finger.

The I/O interfaces 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 608 are configured to provide graphical data to a display for presentation to a user. The graphical data may be representative of one or more graphical user interfaces or any other graphical content as may serve a particular implementation.

The computing device 600 further includes a communication interface 610. The communication interface 610 includes hardware, software, or both. The communication interface 610 provides one or more interfaces for communication (such as, for example, packet-based communication) between the computing device and one or more other computing devices or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI. The computing device 600 further includes a bus 612. The bus 612 includes hardware, software, or both that connects components of computing device 600 to each other.

In the foregoing specification, the invention has been described with reference to specific example embodiments thereof. Various embodiments and aspects of the invention are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

What is claimed is:

1. A method of determining efficacy of a dataset, comprising:
receiving, by a machine-learning (ML) based efficacy scorer, data from a data source, wherein the data comprises a plurality of fields of unknown efficacy;
mapping, by the machine-learning (ML) based efficacy scorer, the data based on a plurality of data quality metrics and based on attributes of the plurality of fields wherein meta-features for the data are obtained;
predicting, by the machine-learning (ML) based efficacy scorer, a value for each of the plurality of data quality metrics using a ML model that takes the meta-features as input, wherein the value indicates whether a corresponding data quality metric is suitable for measuring efficacy of the plurality of fields;
selecting, by the machine-learning (ML) based efficacy scorer, a data quality metric based on the value, wherein the data quality metric measures an efficacy of the plurality of fields; and
monitoring, by an anomaly monitor, the efficacy of the plurality of fields in the data received from the data source based on the data quality metric, wherein fields of the plurality of that are determined to lack efficacy are rejected.

2. The method of claim 1, wherein the ML model is trained by
computing, for each dataset in a set of training datasets, a meta-feature matrix M of size n by f, wherein n is a number of attributes across all datasets, and f is a number of meta-features, wherein meta-features are derived for every attribute of each dataset;
computing, for each dataset in the set of training datasets, a data quality metric matrix Q of size n by m wherein m is number of data quality metrics across all the datasets, and each of the m data quality metrics is computed for every data column/attribute for all the datasets;
providing a ground truth matrix Y of ground-truth data quality labels, wherein each row in Y corresponds to a data-column in some dataset and each columns represents an actual ground-truth data quality metric; and
learning a function ƒ that maps M and Q to Y, such that ƒ([M Q])=Y,
wherein given a new unseen data-attribute/column Xₜₑₛₜ from a user, a relevant data quality metric is predicted as Yₜₑₛₜ=ƒ([ϕ(Xₜₑₛₜ)ψ(Xₜₑₛₜ)]), wherein the meta-feature vector is ϕ(Xₜₑₛₜ) and the data quality metrics is ψ(Xₜₑₛₜ).

3. The method of claim 1, wherein monitoring the efficacy of the fields in the data comprises comparing a new data efficacy value of a field with a distribution of previously stored data efficacy values, and determining the new data efficacy value as anomalous when said value is outside of a minimum value or a maximum value of an inter-quartile range of said distribution.

4. The method of claim 3, wherein monitoring the efficacy of the fields in the data comprises, for categorical values of the fields in the data,
learning an embedding for each categorical value of the data using an autoencoder, wherein a fixed-length scalar vector is obtained that contains semantics of each categorical value;
compressing the fixed-length scalar vector into a condensed vector and learning from the condensed vector a core pattern configured to compress and reconstruct the fixed-length scalar vector; and
identifying a new fixed-length scalar vector obtained from the data as anomalous when the compressed new fixed-length scalar vector cannot be reconstructed from the core pattern.

5. The method of claim 1, further comprising recommending, by an efficacy recommender, solutions to enhance data efficacy of fields in the data based on characteristics of each field that has poor efficacy, wherein said solutions include one or more of interpolating missing values, including neighboring values, standardizing synonymous values, removing invalid values, or merging mutual attributes.

6. The method of claim 5, wherein merging mutual attributes includes training a hybrid deep learning model to understand each data column attribute, including both a header and a column value, wherein said hybrid deep learning model includes a sentence-level recurrent neural network header module and character-level convolutional neural network cell value module, and automatically measures semantic similarity among data attributes and provides an efficacy recommendation of similar data attribute clusters based on the semantic similarity.

7. A system for determining efficacy of a dataset, comprising:
a plurality of data sources;
a statistical efficacy scorer;
a machine-learning based efficacy scorer;
an efficacy recommender;
an anomaly monitor; and
a user interface that includes dashboard visualizations and is configured to receive user inputs;
wherein the machine-learning based efficacy scorer is configured to train a machine-learning (ML) model than predicts a value for each of a plurality of data quality metrics, wherein the machine-learning (ML) model is trained by
computing, for each dataset in a set of training datasets, a meta-feature matrix M of size n by f, wherein n is a number of attributes across all datasets, and f is a number of meta-features, wherein meta-features are derived for every attribute of each dataset;
computing, for each dataset in the set of training datasets, a data quality metric matrix Q of size n by m wherein m is number of data quality metrics across all the datasets, and each of the m data quality metrics is computed for every data column/attribute for all the datasets;
providing a ground truth matrix Y of ground-truth data quality labels, wherein each row in Y corresponds to a data-column in some dataset and each columns represents an actual ground-truth data quality metric; and
learning a function ƒ that maps M and Q to Y, such that ƒ([M Q])=Y,
wherein given a new unseen data-attribute/column Xₜₑₛₜ from a user, a relevant data quality metric is predicted as Yₜₑₛₜ=ƒ([ϕ(Xₜₑₛₜ)ψ(Xₜₑₛₜ)]), wherein the meta-feature vector is ϕ(Xₜₑₛₜ) and the data quality metrics is ψ(Xₜₑₛₜ), and the relevant predicted data quality metrics is presented to the user as a data quality recommendation.

8. The system of claim 7, wherein the plurality of data sources include a plurality of datasets, an efficacy score history, and experience logs, and wherein the efficacy score history is updated by the anomaly monitor, and the experience logs are updated by user inputs received through the user interface.

9. The system of claim 8, wherein the statistical efficacy scorer is configured to compute a set of data quality metrics, to score a field in a dataset by evaluating a weighted sum of one or more of the computed set of data quality metrics, to receive weight adjustments from a user, and to explain to the user how the field score is derived.

10. The system of claim 9, further comprising, for a dataset that includes hierarchical data in a plurality of hierarchy levels, for each level in the hierarchical data, aggregating values for each group of fields that have a common parent node wherein a value for that parent node is computed.

11. The system of claim 7, wherein the efficacy recommender is configured to determine recommended solutions to enhance data efficacy of fields of a dataset based on characteristics of each field that has poor efficacy, wherein each field is associated with an attribute of the dataset, wherein said solutions include one or more of interpolating missing values, including neighboring values, standardizing synonymous values, removing invalid values, or merging mutual attributes, and to output the recommended solutions to the user interface through a recommender API.

12. The system of claim 11, wherein merging mutual attributes includes training a hybrid deep learning model to understand each data column attribute, including both a header and a column value, wherein said hybrid deep learning model includes a sentence-level recurrent neural network header module and character-level convolutional neural network cell value module, and automatically measures semantic similarity among data attributes and provides an efficacy recommendation of similar data attribute clusters based on the semantic similarity.

13. The system of claim 7, wherein the anomaly monitor is configured to monitor data efficacy of a dataset by comparing a new data efficacy value of a field in the dataset with a distribution of previously stored data efficacy values, and to determine the new data efficacy value as anomalous when said value is outside of a minimum value or a maximum value of an inter-quartile range of said distribution, and to output a notification to the user interface through an alert API.

14. The system of claim 13, wherein, for datasets that include categorical values, the anomaly monitor is configured to
learn an embedding for each categorical value of the datasets using an autoencoder, wherein a fixed-length scalar vector is obtained that contains semantics of the categorical value;
compress the fixed-length scalar vector into a condensed vector and learn from the condensed vector a core pattern configured to compress and reconstruct the fixed-length scalar vector; and
identify a new fixed-length scalar vector obtained from a new incoming dataset as anomalous when a compressed new fixed-length scalar vector cannot be reconstructed from the core pattern.

15. A method of determining efficacy of a dataset, comprising the steps of:
determining, by a statistical efficacy scorer, a set of data quality metrics and statistics;
scoring, by the statistical efficacy scorer, a field in a dataset of unknown efficacy with the set of data quality metrics and statistics by evaluating a weighted sum of one or more of the set of data quality metrics, wherein an efficacy score of the field is derived;
presenting, by the statistical efficacy scorer, the efficacy score to the user along with an explanation of how the efficacy score was derived;
receiving, by the statistical efficacy scorer, adjustments of weights for one or more of the set of data quality metrics from the user, wherein an adjusted set of data quality metrics is derived; and
monitoring, by an anomaly monitor, data efficacy of a new, incoming dataset with the adjusted set of data quality metrics.

16. The method of claim 15, wherein providing a set of data quality metrics and statistics comprises one of computing the set of data quality metrics and statistics or receiving manually defined data quality metrics and statistics from a domain expert.

17. The method of claim 15, wherein monitoring data efficacy of the new, incoming dataset comprises comparing a new data efficacy value of a field of the new, incoming dataset with a distribution of previously stored data efficacy values, and determining new data efficacy value as anomalous when said value is outside of a minimum value or a maximum value of an inter-quartile range of said distribution.

18. The method of claim 15, further comprising recommending, by an efficacy recommender, solutions to enhance data efficacy of fields in the new incoming dataset based on characteristics of each data attribute that has poor efficacy, wherein said solutions include one or more of interpolating missing values, including neighboring values, standardizing synonymous values, removing invalid values, or merging mutual attributes.

19. The method of claim 18, wherein merging mutual attributes comprises training a hybrid deep learning model that understands each data column attribute, including both a header and a column value, automatically measuring, using the hybrid deep learning model, a semantic similarity among data attributes of fields in the new incoming dataset, and providing an efficacy recommendation of similar data attributes based on the measured semantic similarity, wherein the hybrid deep learning model includes a sentence-level recurrent neural network header module and character-level convolutional neural network cell value module.

20. The method of claim 15, wherein the data includes hierarchical data that includes fields in a plurality of hierarchy levels, and further comprising, for each level in the hierarchical data, aggregating values for each group of fields that have a common parent node wherein a value for that parent node is computed.
